(19) United States
(12) Patent Application Publication
(10) Pub. No.: US 2026/0166693 A1
(43) Pub. Date: Jun. 18, 2026

(54) Mounting Procedure

(71) Applicant: Silvan Wälchli, Hasle (CH)

(72) Inventor: Silvan Wälchli, Hasle (CH)

(73) Assignee: Silvan Wälchli, Hasle (CH)

(21) Appl. No.: 19/123,923

(22) PCT Filed: Oct. 28, 2022
(86) PCT No.: PCT/EP2022/080270

§ 371 Date: Apr. 24, 2025

(51) Int. Cl. B25B 23/00; B25B 21/00

(52) U.S. Cl. CPC B25B 23/0064; B25B 21/00

(57) ABSTRACT

In a method for mounting a component with a fastening element on an underground, using a hand tool with a drive for fastening the fastening element and a control unit, a position of the hand tool relative to the underground is determined. In addition a position of the hand tool relative to the component is determined. The hand tool for mounting the component with the fastening element on an underground includes a drive for fastening the fastening element, a control unit, a detection device for detecting a position signal of the hand tool relative to the underground, and means for detecting a position of the hand tool relative to the component.

### TECHNICAL FIELD

The invention relates to a method for mounting a component with a fastening element on a substrate, using a hand tool with a drive for fastening the fastening element, as well as a control unit that determines the position of the hand tool relative to the substrate. The invention also relates to a hand tool.

### BACKGROUND ART

On construction sites, components regularly have to be installed in the correct position and also in the correct alignment. This applies in particular, but not exclusively, to components such as wall panels, floor tiles, decking, etc. Typically, a frame or grid is pre-assembled for installation, on which the components are then mounted. Installation is usually done with wood screws. Various techniques are used to achieve a particularly even installation. One common method is to use adjusting screws to adjust the position of the component relative to the underground. Adjusting screws are wood screws that can be used to attach a component to an underground at an adjustable distance. They have saw-tooth shaped grooves under the screw head, which dig into the wood in such a way that there is an axial form fit between the adjusting screw and the component. This means that the adjusting screw can no longer move in its longitudinal direction in relation to the component. If such an adjusting screw is then turned, it moves axially only in the wall or in the dowel located in it. The distance between the batten and the wall can thus be specifically set (adjusted).

Various techniques are also known for monitoring the target position. On the one hand, conventional water levels, laser levels and the like can be used. These techniques have the disadvantage that, as a rule, more than one worker is needed to assemble such a component. Furthermore, the precision is usually insufficient. It is also known to use a line laser to create a plane parallel to the target position of the component. This allows the assembler to visually check whether the component is in the target position. This method has the disadvantage that the assembler still has to visually check whether the target position has been reached. This is inefficient on the one hand and rather inaccurate on the other.

U.S. Pat. No. 5,484,026 B1 (Nikon Corporation) discloses a hand-held electric device with a sensor that can be used to horizontally mount a floor or ceiling element, whereby a reference plane is created with a light emitter that can be detected by the sensor. As soon as the sensor detects the reference plane, the motor is switched off. In a further embodiment, the drive speed is reduced as soon as the sensor is in the vicinity of the reference plane. This allows a component to be mounted relatively precisely. However, the position of the screw is used as a reference. This is disadvantageous because the screw usually does not have a unique position relative to the component—sometimes the screw head is flush with the surface of the component, sometimes the screw is more or less countersunk in the component.

The European patent application EP 3 656 508 A1 (Fischerwerke) discloses a hand tool with a light sensor that can interact with a leveling laser in such a way that when the light sensor is exposed to the light of the leveling laser, the control unit of the hand tool switches off the drive. The light sensor can be arranged on a cladding tube that comes into contact with the workpiece. This means that the position of the sensor is independent of the depth at which the screw is sunk into the workpiece. The cladding tube is used to create a method that works with greater precision than the Nikon method. However, the cladding tube has the disadvantage that the position of the screw cannot be determined optically by the technician or by the leveling laser. This method is therefore cumbersome and difficult to implement. The cladding tube makes it more difficult to hit the screw head with the hand tool (e.g. with a screw bit). It cannot be visually checked whether the screw is screwed in sufficiently deep. Furthermore, it is not possible to check whether the screw is screwed in at a right angle or in the desired orientation to the surface of the component.

The known methods for assembling a component with a fastening element on a substrate, using a hand tool, have the disadvantage that they are not very precise and are cumbersome to use, and are therefore inefficient for achieving precise assembly of a component on a substrate.

### SUMMARY OF THE INVENTION

The object of the invention is to create a method and a suitable hand tool for use in the aforementioned technical field, whereby a component can be fastened with a fastening element on an underground particularly precisely and efficiently in a predetermined position.

The solution to the problem is defined by the features of claim 1. According to the invention, a position of the hand tool relative to the component is also determined.

A hand tool for mounting a component with a fastening element on a substrate includes a drive for fastening the fastening element and a control unit. The hand tool includes a detection device for detecting a position signal of the hand tool relative to the substrate. The hand tool also includes means for detecting a position of the hand tool relative to the component.

By additionally determining a position of the hand tool relative to the component, a method is obtained which is independent of the position of the fastening element relative to the component, whereby a particularly precise positioning of the component relative to the underground can be achieved.

If only the position of the hand tool is monitored, only the end position of the fastener is monitored, but not that of the component. If the fastener is designed as a screw, for example, the end position of the screw relative to the component is not always constant—in one case, the screw head may be exactly flush with one surface of the component, but in another case, the screw head may be countersunk in the component. Depending on the component, this can result in deviations from the target position of several millimeters to centimeters during assembly. When mounting wall elements, floorboards or the like, for example, this can lead to undesirable unevenness. The fact that the position of the component is also monitored using the hand tool, together with the monitoring of the position of the hand tool relative to the underground, means that such a deviation from the target position can be monitored and corrected. To do this, the position of the hand tool relative to the underground can be used to determine whether the target position of the hand tool has been reached. Subsequently, or in parallel, the position of the hand tool relative to the component can be used to determine whether the target position of the component has also been reached. If yes, the drive is switched off by the control unit and the process is terminated. If no, an actual distance between the hand tool and the component is determined—if this is greater than a nominal distance between the hand tool and the component, then this means that the component is already too close to the underground. The fastener must therefore be repositioned so that the component moves back from the underground by the incorrect distance. Accordingly, if the actual distance is smaller than the target distance, it follows that the component is too far away from the underground, and the fastener must be used to move the component towards the underground by the incorrect distance. In a further variant, the relative positions of the hand tool relative to the underground and of the hand tool relative to the component can be continuously monitored. In this case, for example, a target position of the hand tool relative to the underground can also be continuously corrected.

Determining the position of the hand tool relative to the component has the advantage, in particular over the Fischerwerke cladding tube (EP 3 656 508 A1), that the fastening element remains visible. This improves the handling of the hand tool, which in turn makes the method more efficient. The Fischerwerke cladding tube also has the disadvantage that it is used only to monitor the component, but not the fastener. This means that there is a risk that the drive will be switched off after the component has been correctly positioned, even though the fastener is not yet in the target position. Furthermore, the cladding tube can be a sterical hindrance, especially when working in a peripheral area (near the wall) or when the component has structures whereby the cladding tube is positioned differently relative to the component depending on the position of the fastener (e.g. depending on the position, it rests on a strut or similar).

To determine the position of the hand tool relative to the underground, a device is preferably provided that is fixed relative to the underground. The device is preferably designed in such a way that a contactless determination of a position of the hand tool relative to the device and thus also relative to the underground can be determined. The contactless determination of the position can be carried out in different ways.

In this document, the term “switched off” with regard to the drive refers to an action that stops the drive. This can be a clutch, a power interruption or similar. An interruption of the drive by means of a clutch has the advantage that a run-on of the drive can be prevented or at least reduced. In contrast, an electronic interruption of the drive is particularly easy to accomplish.

The term “underground” is understood to mean, for example, a floor, a wall, a ceiling, a grate or similar. The underground thus forms the fixed reference system by which a target position of the component is determined. However, a specialist is aware that a relative position of the hand tool relative to the underground can also be determined indirectly (e.g. a line laser standing on a platform or tripod; in this case, the relative position to the floor is given by the platform or tripod of the line laser). The component does not necessarily have to be mounted directly on the underground, but can also be mounted indirectly, for example on a pre-assembled grid on the underground.

On the construction site, both in interior and facade construction, when laying wooden floorboards in indoor and outdoor areas and the like, particular care must be taken to ensure that such components are mounted evenly. In the case of a floor, especially in an outdoor area, a slope may also be desired so that rainwater runs off better. This makes the method according to the invention particularly suitable for such applications. With the present method, for example, terrace supports and terrace floorboards can be laid efficiently and precisely. In these cases, the component is preferably designed as a floor plate, wall plate, ceiling plate, as a grid for fastening such plates or the like. Furthermore, the method can be used for building a roof truss, in particular to achieve the correct roof pitch. The component can in particular include a plasterboard, parquet elements, slatted frames, Gis frames, but also railing elements, fence elements, post bases and other elements.

However, it is clear to those skilled in the art that precise assembly of components is also advantageous in other areas, whereby the method according to the invention can also be used, for example, in vehicle construction (e.g. interior finishing of railroad cars, ships, aircraft, etc.). Furthermore, the method can also be used in road construction, bridge construction, etc. In this case, the components do not necessarily have to be mounted flat; the method also makes it possible, for example, to create a predetermined curvature (e.g. by arranging several components in a polygonal pattern). Experts are familiar with any number of examples of this.

Preferably, the drive is controlled with the control unit depending on the position of the hand tool relative to the underground and the position of the hand tool relative to the component. In this case, the hand tool includes a control unit that processes data on the relative position of the hand tool to the underground on the one hand and data on the relative position of the hand tool to the component on the other. To reach the target position of the component, it is typically not sufficient to specify a target position for the hand tool, since the fastener in the target position of the component does not necessarily assume a reproducible end position. The control unit is now used to process the data of the relative position of the hand tool to the underground and the data of the relative position of the hand tool to the component in such a way that the target position of the component is reached independently of the end position of the fastener. To do this, as explained above, on the one hand the position of the hand tool (and thus the position of the fastening element) and on the other hand the position of the component are monitored. As soon as the theoretical target position of the hand tool is reached, the relative position of the hand tool to the component is used to determine whether the component is already in the target position. If not, the control unit calculates a correction movement that is executed by the drive. Preferably, a further control measurement is then carried out to check whether the component has now reached the target position. As soon as the target position of the component is reached, the process is aborted, i.e. the drive is switched off.

In variants, the position of the hand tool relative to the underground or the position of the hand tool relative to the component can also be signaled to the user only, for example by means of a beep, a signal light, a vibration of the device, etc. For example, after the hand tool has reached the target position relative to the underground, the hand tool can signal whether the target position of the component has been reached. If not, a “+” can be used to indicate that the fastener needs to be driven in further, while a “−” can be used to indicate that the fastener needs to be driven back to bring the component into the target position. The skilled person is aware of further embodiments.

Preferably, a direction of rotation of the drive is determined by the control unit as a function of the position of the hand tool relative to the underground and/or the position of the hand tool relative to the component. Preferably, the direction of rotation is determined by the control unit on the basis of the data on the position of the hand tool relative to the underground and/or the position of the hand tool relative to the component. This makes it possible to take into account whether the component has a positive or negative difference distance to the target position. If the fastener is designed as a screw, for example, the sign of the difference distance can be taken into account by selecting the direction of rotation of the drive in order to reach the target position of the component. This design of the method is particularly advantageous when using an adjusting screw or similar. In variants, the choice of direction of rotation can also be advantageously used when screwing a nut onto a threaded rod that serves as a support for the component.

In variants, the determination of the direction of rotation can also be dispensed with.

Preferably, the hand tool includes a screwing device. The fastening element is preferably designed as a screw, in particular as an adjusting screw. In practice, it has been shown that the exact positioning of components on the construction site is typically carried out using adjusting screws, which makes the method particularly advantageous when using adjusting screws. In this area, the method can be used particularly precisely and efficiently. The screwing device can, for example, be designed as a drill/screwdriver, in particular as a cordless drill/screwdriver (colloquially called a cordless drill). In principle, commercially available power drills can also be used.

In variants, the fastener can also be present as a threaded rod with a nut, whereby the screwing device has a corresponding tool (socket or the like). A person skilled in the art is familiar with further fasteners.

Preferably, the drive is controlled by the control unit as a function of the thread pitch of the screw. The control unit is preferably designed in such a way that it can process data on the position of the hand tool relative to the underground and data on the position of the hand tool relative to the component. In particular, the control unit can be used to determine a distance over which the screw must be screwed in. Preferably, in the method, a number of rotations with which the screw must be screwed into the underground in order to reach the target position of the component or the hand tool relative to the underground is determined on the basis of the thread pitch of the screw and the determined distance. Since, in particular with wood screws, the thread pitch can essentially be assumed to be constant after a certain screwing-in depth, the screw is preferably initially screwed into the underground until the screw tip is completely sunk into the underground, in order to then determine the necessary number of turns of the screw on the basis of a residual distance determined by the control unit. Preferably, the drive is then controlled in such a way that the screw is screwed into the underground with the necessary number of turns. In a preferred variant, it is then checked again whether the target position of the component has been reached. With the control of the drive depending on the thread pitch, the screw can be screwed in particularly precisely, especially since any subsequent turning of the drive can be avoided or taken into account and calculated.

In variants, the drive can also be controlled in such a way that the rotational speed is reduced as the distance of the component to the target position decreases. In this case, it is not necessary to take the thread pitch into account.

Preferably, the hand tool includes detection means for detecting the thread pitch of the screws in order to calibrate the hand tool on the basis of the thread pitch, wherein in particular the thread pitch is determined by dividing a difference distance between the hand tool and the component by a corresponding number of turns of the screw during operation of the hand tool, or wherein in particular the thread pitch is entered manually in the control unit.

In the first preferred variant, the thread pitch is determined during the screwing in of the screw. This process can be carried out once and does not have to be repeated as long as the same thread pitch is used for the screws. Because a position of the hand tool relative to the component can be determined, a differential distance can be determined during the screwing in of the screw (after the tip of the screw has been completely screwed in). This difference distance is divided by the number of turns to determine the thread pitch (e.g. 50 mm difference distance at 25 turns gives a thread pitch of 2 mm per turn).

Preferably, the control unit includes an input device that can be used to enter a thread pitch. The hand tool thus preferably includes means for entering the thread pitch, in particular, for example, a keyboard, a touch screen or the like. Furthermore, the hand tool can also have communication means so that it can be programmed by means of a computer, an app or the like. Furthermore, the hand tool or the computer can have a code reading device, with which a bar code, a QR code or the like can be read in, via which the thread pitch can be determined. The skilled person is aware of many variants in this regard.

In some variants, the input device via which the thread pitch can be entered can also be dispensed with. In this case, the thread pitch can be determined during operation (see above).

Preferably, the control unit calculates a number u of screw turns based on the difference between an actual screw position and a target screw position, whereby the hand tool is controlled in such a way that the drive is stopped after u screw turns. This creates a particularly efficient method for assembling a component, since after determining the number of turns of the drive, it can be controlled particularly precisely to reach the target position of the component particularly efficiently.

In variants, a difference distance of the actual position of the component to the target position of the component can be determined in order to monitor the achievement of the target position based on the position of the hand tool relative to the underground and the position of the hand tool relative to the component.

Preferably, the position of the hand tool relative to the underground is determined using a passive system, whereby a transmitter device is provided that is fixed relative to the underground and emits a signal in a specific direction or in a specific plane (e.g. a line laser). The hand tool preferably includes one or more sensors for detecting the signal emitted by the device. The sensor can be designed in such a way that exactly one position in the longitudinal direction of the hand tool (i.e. in the direction in which the hand tool moves during the assembly of the fastening means) can be detected. On the other hand, the sensor can also be designed in such a way that several positions in the longitudinal direction of the hand tool can be detected, or several sensors can be provided in the longitudinal direction on the hand tool. This allows different positions of the hand tool in the longitudinal direction to be detected and distinguished.

In the method, the hand tool can thus be positioned to assemble the component. As soon as the sensor detects the signal emitted by the transmitting device, the position of the hand tool can be determined from this, at least in one direction.

It will be appreciated that the transmitting device may also be adapted to transmit different signals, which may be detected by one or more sensors of the handset, each of the signals corresponding to a position of the hand tool. In particular, the transmitting device can be designed in such a way that several different signals are emitted in parallel planes. This means that a suitable sensor, which can distinguish the different signals, can be used to determine several different positions of the hand tool relative to the transmitting device.

In a further variant, the hand tool can comprise the transmitting device, while a receiving device fixed relative to the underground detects a position of the hand tool.

In a further preferred variant, an active method is used, in particular, for example, a light source is used to illuminate the hand tool at an angle and the reflected light is detected by a sensor. This allows the position of the hand tool to be detected. It will be appreciated that sound waves or the like can also be used to determine the position of the hand tool. In a further variant or in addition, the surface of the hand tool can be measured in order to determine a position and an orientation of the hand tool. This can be used, for example, to signal to the user of the hand tool whether he is in the right place and whether the hand tool is correctly aligned with respect to the underground and/or the component. This means that a fastening element, in particular for example a screw or the like, can be positioned, aligned and screwed in with particular precision, in order in turn to achieve a particularly precise fastening of the component on the underground. Corresponding sensor designs are known to those skilled in the art. For example, an electronic image converter can be used, in particular, for example, a CCD or CMOS camera or a PSD (position sensitive device), an OPS (optical position sensor), etc., to detect the scattered light reflected from the hand tool. The technical implementation is known to those skilled in the art.

In a further variant, the position is determined by triangulation, in particular, for example, laser triangulation. The person skilled in the art is aware of further active methods for determining a position of the hand tool.

In a particularly preferred variant, the position of the hand tool relative to the underground is determined using a line laser. Line lasers are easy to use and inexpensive. The line laser can be used to project a line and/or a plane that is aligned parallel to a target position of the component in the application. Preferably, the hand tool includes a sensor for detecting the line laser. The control unit is designed to control the drive of the hand tool depending on the sensor. It is particularly preferred that the control unit switches off the drive as soon as the sensor detects the laser.

In variants, other techniques may be provided to determine a position of the hand tool relative to the underground (see above).

Preferably, the position of the hand tool relative to the component is determined using a measuring laser. Accordingly, the means for detecting a position of the hand tool relative to the component preferably include a measuring laser. This allows a distance between the hand tool and the component to be determined directly in a particularly simple and reliable manner.

In variants, a mechanical measuring device can also be provided, for example a longitudinally displaceable pin, which is arranged laterally on the hand tool, the position of which can be detected electronically, for example. Further variants are known to those skilled in the art.

Preferably, a system for mounting a component includes a hand tool and means for generating the position signal, in particular a line laser. In this combination, the system can be used directly to mount components precisely and efficiently. Preferably, the hand tool is designed in such a way that the system can be formed together with a commercially available line laser.

Preferably, the hand tool comprises a drive shaft with a tool holder, in particular a drill chuck or a bit holder, wherein the measuring laser is arranged parallel to an axis of rotation of the drive shaft and aligned in the direction of the tool holder. Preferably, the measuring laser is attached to the side of the hand tool so that the laser propagation direction is parallel to the direction in which the fastener is driven into the underground, in particular the screw is screwed into the underground. In a particularly preferred embodiment, the position of the measuring laser on the hand tool can be changed. This can be advantageous, for example, when the component is to be mounted in a corner of a room. The measuring laser's position can be changed by disassembling and reassembling it on the hand tool. In a further embodiment, the measuring laser can be arranged in particular transversely to a laser axis on the hand tool so that it can be moved or on the circumference of the hand tool so that it can be rotated. Furthermore, it is conceivable to design the measuring laser so that it can be swiveled, so that the laser axis can be swiveled. Finally, the measuring laser can also be arranged on the hand tool so that the distance between the laser axis and the drive axis of the hand tool can be varied. The measuring laser (as well as the sensor) can be designed so that a standard cordless drill can be retrofitted with it. The person skilled in the art is aware of several possibilities for transmitting the data from the measuring laser to the control unit (wired, via a wireless network such as Wifi, WLAN or via Bluetooth, etc.) and for supplying the measuring laser with power (battery, rechargeable battery of the cordless drill, etc.). The measuring laser can include a memory, whereby data (control data, measurement data, etc.) can be stored. The measuring laser can also be designed to be used independently of the cordless drill (e.g. it can be decoupled from the cordless drill). Instead of the cordless drill, a mains-powered device can also be provided, in particular, for example, a conventional drill or similar.

In variants, the measuring laser can also be mounted on the hand tool in a different way, and the person skilled in the art is also aware of variants in this regard.

Preferably, a target position of the component relative to the underground is set. This has the advantage that the target position does not have to be corrected. During the method, a position of the component relative to the hand tool is preferably monitored, whereby a target position of the hand tool is corrected based on the position of the component relative to the hand tool. If the position of the component relative to the hand tool is determined using a measuring laser, the monitoring is preferably carried out by continuously measuring the distance between the hand tool and the component.

In variants, a target position of the hand tool relative to the underground can also be set. In this case, the target position is preferably corrected at least once, in particular continuously, depending on the relative position between the hand tool and the component.

Other advantageous embodiments and combinations of features come out from the detailed description below and the entirety of the claims.

### BRIEF DESCRIPTION OF THE DRAWINGS

The drawings used to explain the embodiments show:

FIG. 1 a schematic representation of an angled view of an arrangement comprising a panel to be mounted on a grate, a line laser and a cordless drill with a measuring laser;

FIG. 2a a schematic representation of a side view of an arrangement comprising a panel to be mounted on a grate, a line laser and a cordless drill with a measuring laser, after the tip of the adjusting screw has penetrated the panel;

FIG. 2b a schematic representation according to FIG. 2a, wherein the adjusting screw is screwed a distance further into the panel to determine a thread pitch of the distance screw;

FIG. 2c a schematic representation according to FIG. 2a, wherein the adjusting screw is fully screwed in;

FIG. 2d a schematic representation according to FIG. 2c, wherein the adjusting screw is screwed back so far that the target position of the panel is reached;

FIG. 3a a schematic representation according to FIG. 2d, wherein the screw head of the adjusting screw is countersunk in the panel; and

FIG. 3b a schematic representation according to FIG. 3a with the corrected position of the panel.

In the figures, the same components are given the same reference symbols.

### PREFERRED EMBODIMENTS

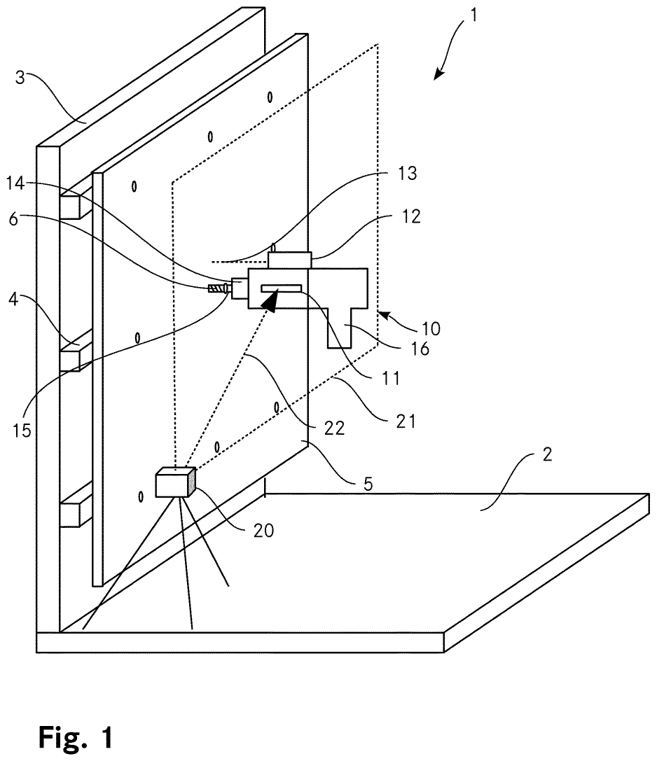

FIG. 1 shows an arrangement for mounting a panel 5 on a wall 3 in a room 1. For the purposes of illustrating the method, the room 1 comprises a floor 2 and a wall 3, which are at right angles to one another. In the present case, the panel 5 is mounted on a grid consisting of several battens 4 mounted parallel to each other on the wall 3. The panel 5 is attached to these battens 4 using adjusting screws 6. A cordless drill 10 with a handle 16 and a chuck 14 for holding a screw bit 15 is provided for mounting the screws 6.

To achieve precise mounting of the panel 5, a plane 21 is spanned with a line laser 20, which lies parallel to a target position of the panel 5. The line laser 20 is installed on the floor 2 for this purpose, so that the line laser 20 assumes a fixed position relative to the floor 2, the wall 3 and, in this case, also the grid with the several parallel strips 4.

The cordless drill 10 includes a sensor 11 with which the plane 21 can be detected. This means that the line laser 20 can be used to determine the position of the cordless drill 10 relative to the line laser 20 and thus relative to the floor 2 or the wall 3. When a laser beam 22 located in the plane 21 reaches the sensor 11 of the cordless drill 10, this is detected by a control unit located in or on the cordless drill 10. In conventional systems (e.g. according to Fischerwerke), the drive of the cordless drill 10 is stopped at this moment. However, since only the position of the adjusting screw 6 can be detected (indirectly) with the position of the cordless drill 10, it cannot be ensured that the panel 5 is also in the target position.

To ensure this, the cordless drill 10 also includes a measuring laser 12, which can be used to monitor the position of the cordless drill 10 relative to the panel 5. The distance 13 measured by the measuring laser 12 is used as a further criterion for switching off the drive of the cordless drill 10.

In the method, the position of the cordless drill 10 can now be monitored using the line laser 20. As soon as the target position of the cordless drill 10 is determined, the measuring laser 12 is used to check whether the panel 5 is in the target position. If it is, the drive of the cordless drill 10 is switched off. If not, the error distance is determined. Depending on the misalignment, a direction of rotation of the drive is determined in order to transfer the panel 5 to the target position using the adjusting screw 6. In the first embodiment of the method, the target position of the panel 5 is monitored exclusively with the measuring laser 12.

In a further embodiment of the method, the sensor 11 of the cordless drill 10 is designed in such a way that, depending on the point of incidence of the laser beam 22 on the sensor 11, different relative positions of the cordless drill 10 to the line laser 20 can be determined. This means that a target position of the cordless drill 10 relative to the line laser 20 can also be tracked in the method as a function of the measured distance of the cordless drill 10 from the panel 5. In particular, the position of the panel 5 can also be determined exactly relative to the line laser 20 via the line laser 20 and the measuring laser 12, i.e. even if the target position of the cordless drill 10 had to be corrected.

The method presented can also be used to mount the grating 4, after which the panel 5 can be mounted without the support of the line laser 20 and the measuring laser 12. Furthermore, the method can also be used to mount floor gratings, floorboards, etc.

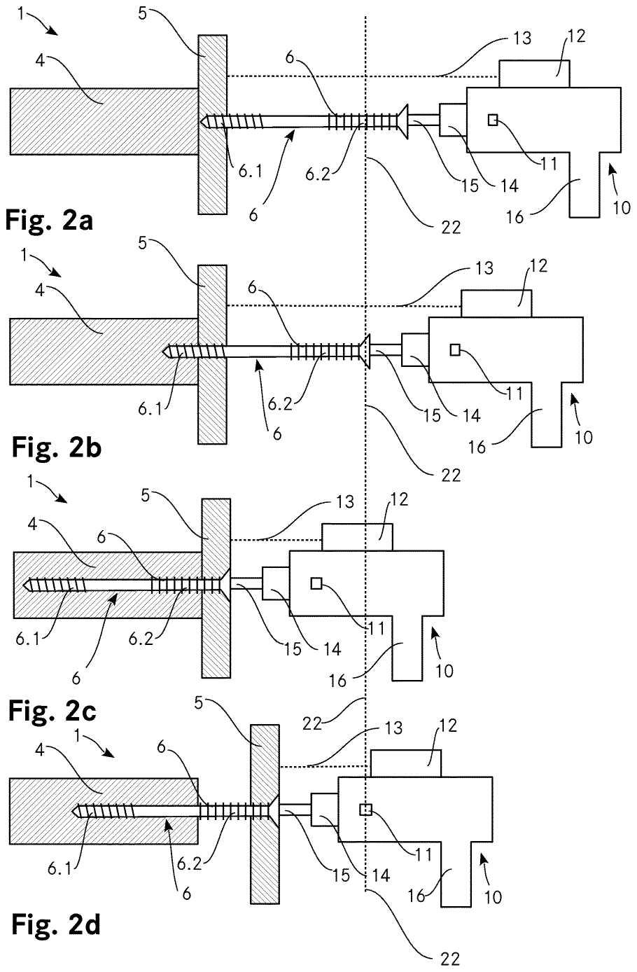

FIG. 2a shows a schematic representation of a side view of an arrangement 1 comprising a panel 5 to be mounted on a grate 4, a beam 22 of a line laser 20, a cordless drill 10 with a measuring laser 12 and an adjusting screw 6, with which the panel 5 is attached to the grate 4.

The adjusting screw 6 comprises a distal screw area, which comprises a conventional thread 6.1 for screwing into wood or similar materials. The distal area is followed by an intermediate area without a thread. Adjacent to the screw head, the adjusting screw 6 comprises sawtooth-shaped grooves 6.2 that dig into the wood in such a way that an axial form fit is created between the adjusting screw 6 and the component. This means that once the adjusting screw 6 has been screwed into the panel 5 up to the screw head, it can no longer move in its longitudinal direction relative to the panel 5.

In a first step, the thread pitch of the adjusting screw 6 is determined. This can be done once, as long as screws with the same thread pitch are used. For calibration, the control unit can include a calibration program that, when activated, performs a certain number of rotations and determines a corresponding differential distance using the measuring laser 12. The thread pitch can be calculated by dividing the difference distance by the number of rotations. The thread pitch can be used in the method to achieve a target position of the panel 5 particularly efficiently—if the difference distance to the target position is known, the control unit can determine the number of rotations required by the drive and control the drive accordingly so that the rotations are executed. This means that the target position can be reached particularly quickly and precisely, without risking negative effects due to the drive running on or the like. The drive can thus be optimized for speed, in particular during operation, since a corresponding power profile for the drive can also be created based on the number of revolutions. For example, a post-rotation due to the inertia of the drive or a clutch can be calculated and thus the drive can be switched off or decoupled prematurely.

FIG. 2a now shows the adjusting screw 6 after the tip has penetrated the panel 5. The adjusting screw 6 is screwed into the panel 5 to such an extent that that the thread 6.1 now penetrates the panel 5 at a constant pitch per revolution, i.e. at least the tip of the adjusting screw 6 is inside the panel 5. In this position, the length of the measuring beam 13 is determined using the measuring laser 12. The drive is then activated to perform a certain number of turns. This causes the adjusting screw 6 to penetrate further into the panel 5 and the grate 4. This is shown in FIG. 2b.

In this position, the length of the measuring beam 13 is determined again using the measuring laser 12. The (positive) difference between the two lengths determined is now divided by the number of turns to obtain the thread pitch. Using the distance, the control unit can now calculate the number of turns that the drive of the cordless drill 10 must perform to reach the target position of the panel 5.

In the regular operation for mounting panel 5, the adjusting screw 6 is fully screwed in as a first step. FIG. 2c shows this situation. The screw head is perfectly flush with panel 5, so this figure represents an ideal constellation.

In the next step, the adjusting screw 6 and thus the panel 5 are removed from the grate 4 by turning the drive backwards with the cordless drill 10 until the laser beam 22 of the line laser 20 is detected by the sensor 11 of the cordless drill 10 and the drive is switched off. This situation is shown in FIG. 2d. The measuring laser 12 is now used to measure the distance 13 to ensure that the panel 5 (and not just the adjusting screw 6) is in the correct position. This is the case in FIG. 2d, so the drive is switched off.

However, the ideal constellation does not always occur. Typically, when the adjusting screw 6 is fully screwed in, the screw head does not always align perfectly with the surface of the panel 5, but is more or less countersunk in the panel.

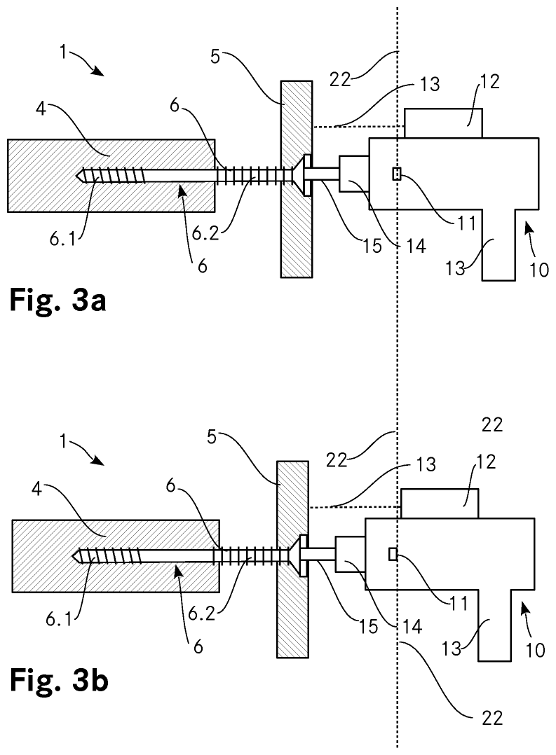

FIG. 3a shows such a constellation, in which the screw head of the adjusting screw 6 is countersunk in the panel 5. The laser beam 22 is detected by the sensor 11 of the cordless drill 10, although the panel 5 is not in the target position. The panel 5 is positioned too far away from the grate 4 by the distance by which the screw head is countersunk in the panel 5. This error distance is now determined by the measuring laser 12 and passed on to the control unit. The control unit calculates the direction of rotation and the number of rotations for the cordless drill 10 on the basis of the error distance, in order to subsequently control the drive accordingly. After the number of rotations has been completed, the drive is switched off. This situation can be seen in FIG. 3b. It should be noted that in this end position, especially if the sensor 11 can only detect one point, the sensor 11 does not detect the laser beam 22 and the measuring laser 12 continues to measure the distance as being too short-nevertheless, the target position of the panel 5 has been reached.

It is clear to those skilled in the art that determining the thread pitch is not mandatory. The method also works by only measuring the distances using the measuring laser 12. To do this, the system can include a two-dimensional sensor as sensor 11, which can determine the position of the cordless drill 10 relative to the line laser 20 over an area. This means that the correction (FIGS. 3a, 3b) can also be made by monitoring with the line laser 20 instead of via the number of revolutions of the drive.

In summary, it can be seen that the invention provides a method for assembling components that enables fast and precise assembly and, in particular, can correct irregularities during assembly, especially those due to the screw-in depth of the screw in the component.

1. A method for mounting a component having a fastening element on an underground, using a hand tool having a drive for fastening the fastening element and a control unit, wherein a position of the hand tool relative to the underground is determined, and wherein, in addition, a position of the hand tool relative to the component is determined.

2. The method according to claim 1, wherein the drive is controlled by the control unit as a function of the position of the hand tool relative to the underground and the position of the hand tool relative to the component.

3. The method according to claim 1, wherein a direction of rotation of the drive is determined by the control unit as a function of the position of the hand tool relative to the underground and/or of the position of the hand tool relative to the component.

4. The method according to claim 1, wherein the hand tool comprises a screwing device and the fastening element comprises a screw or an adjusting screw.

5. The method according to claim 4, wherein the drive is controlled by the control unit as a function of a thread pitch of the screw.

6. The method according to claim 5, wherein the hand tool comprises detection means for detecting the thread pitch of the screw, to calibrate the hand tool on the basis of the thread pitch, wherein the thread pitch is determined by dividing a differential distance between the hand tool and the component by a corresponding number of revolutions of the screw during operation of the hand tool, or wherein the thread pitch is entered manually in the control unit.

7. The method according to claim 4, wherein a number u of revolutions of the screw is calculated by the control unit on the basis of a difference between an actual position of the screw and a target position of the screw, the hand tool being controlled in such a way that the drive is stopped after u revolutions of the screw.

8. The method according to claim 1, wherein the position of the hand tool relative to the underground is determined using a line laser.

9. The method according to claim 1, wherein the position of the hand tool relative to the component is determined using a measuring laser.

10. The method according to claim 1, wherein a nominal position of the component relative to the underground is set and, during the method, a position of the component relative to the hand tool is monitored, a nominal position of the hand tool being corrected on the basis of the position of the component relative to the hand tool.

11. A hand tool for mounting a component having a fastening element on an underground, by using a method according to claim 1, the hand tool comprising a drive for fastening the fastening element and a control unit, the hand tool further copmrising a detection device for detecting a position signal of the hand tool relative to the underground, wherein the hand tool further comprises means for detecting a position of the hand tool relative to the component.

12. The hand tool according to claim 10, wherein the control unit is configured in such a way that the drive is controlled as a function of the position of the hand tool relative to the underground and of the position of the hand tool relative to the component.

13. The hand tool according to claim 10, wherein the means for detecting a position of the hand tool relative to the component comprise a measuring laser.

14. The hand tool according to claim 12, wherein the hand tool further comprises a drive shaft with a tool holder, or a drill chuck or a bit holder, the measuring laser being arranged parallel to and offset from an axis of rotation of the drive shaft and being aligned in the direction of the tool holder.

15. The hand tool according to claim 10, wherein the control unit comprises an input device via which a thread pitch can be input.

16. A system comprising a hand tool according to claim 10 and means for generating the position signal, comprising a line laser.
